(19) United States
(12) Patent Application Publication
(10) Pub. No.: US 2009/0247775 A1
(43) Pub. Date: Oct. 1, 2009

(54) PROCESS FOR THE PREPARATION OF HYDROCARBYL HALIDES

(76) Inventors: Andrea Comini, Lodi (IT); Ganesh Warawdekar Mayukh, Mumbai (IN); Padmakar Gokhale Anand, Mumbai (IN); Shantilal Kasliwal Rajendra, Mumbai (IN); Anil Bendale Gita, Mumbai (IN)

Correspondence Address: FISH & RICHARDSON P.C., P.O BOX 1022, Minneapolis, MN, 55440-1022, US

(21) Appl. No.: 11/569,746

(22) PCT Filed: May 20, 2005
(86) PCT No.: PCT/EP05/05496

§ 371 Date: Apr. 4, 2008

(30) Foreign Application Priority Data
May 28, 2004 (IT) MI2004A001086

(51) Int. Cl. C07F 9/90; C07F 7/22; C07F 3/06; C07F 3/08

(52) U.S. Cl. 556/70; 556/100; 556/101; 556/128

(57) ABSTRACT

Described is a process for the preparation of hydrocarbyl metal halides, such as alkyl tin chlorides, in which a reaction between the metal in its metallic state and a hydrocarbyl halide is catalyzed by a dihydrocarbyl sulfoxide or a dihydrocarbyl formamide in the presence of a hydrocarbyl metal halide and wherein the pressure of the reaction vessel is varied during the reaction.

### FIELD OF THE INVENTION

The invention relates to a process for the preparation of hydrocarbyl metal halides, such as alkyl tin chlorides, in which a reaction between the metal in its metallic state and a hydrocarbyl halide is catalyzed by a complex formed between a hydrocarbyl metal halide and a dihydrocarbyl sulfoxide or a dihydrocarbyl formamide and wherein the pressure of the reaction vessel is varied during the reaction.

### BACKGROUND OF THE INVENTION

Hydrocarbyl substituted tin halides, such as methyl tin chloride, are very useful in the preparation of stabilizers for polymers, especially halogenated polymers, such as polyvinyl chloride resins, chlorinated paraffins, and the like. Various methods have been suggested to prepare hydrocarbyl tin chlorides. To date none has been completely satisfactory.

U.S. Pat. No. 3,901,821 A1 describes the preparation of dimethyl tin dichloride by reacting tin metal with methyl chloride at 65° to 230° C. in the presence of a catalyst system. As the catalyst system tin tetrachloride and trihydrocarbyl phosphine or trihydrocarbyl amine having 3 to 24 carbon atoms are employed. According to the cited document, dimethyl tin dichloride can be obtained in high yields and very light colour with little or no toxic trimethyl tin chlorides and without the need of recycling or other subsequent chemical purification. However, the preparation of dimethyl tin chloride according to the described method results in the formation of an intolerable amount of methyl tin trichloride. Furthermore, the obtained product is always a mixture of dimethyl tin and monomethyl tin compounds of varying compositions. The employed catalyst cannot be recycled. Another major drawback is the fact that the reaction cannot be performed in a stainless steel reactor due to corrosion problems. Alternative materials are, however, very expensive. Finally, the quantity of catalyst required is very high. When phosphines are used as catalysts, the reaction can be very exothermal, which may result in a problem when performing the reaction on plant scale. Due to the pyrophoric nature of phosphines, their handling is difficult and needs a high safety standard. Another drawback lies in the fact that phosphines are usually very expensive. The safer triphenyl phosphine, however, is not sufficiently reactive as a catalyst in the described reaction.

U.S. Pat. No. 3,954,820 A1 describes the preparation of hydrocarbyl metal halides such as alkyl tin chlorides. According to the document the reaction between the metal in its metallic state and the hydrocarbyl halide is catalyzed by the complex formed between a hydrocarbyl metal halide and a dihydrocarbyl sulfoxide. The process according to the cited reference, however, exhibits the drawback of very long reaction times. Additionally, though the described process seems to results in high yields of the desired product, the described methods require a very high level of process safety. The described complete introduction of methyl chloride into a reaction vessel and subsequent heating of the reaction vessel can lead to pressures of about 6205,275 to about 6894,75 kPa (900 to 1000 psi). A pressure in this order of magnitude can only be handled by equipment with very high safety standards. Such equipment, however, is costly and often cumbersome to use, which decreases the economic efficiency of the described processes.

### SUMMARY OF THE INVENTION

It was an object of the present invention to provide a new process for the preparation of dihydrocarbyl metal halides, which remedies the above deficiencies of the processes according to the prior art. It has thus especially been an object of the present invention to provide a process for the preparation of dihydrocarbyl metal halides, which is more convenient to carry out than the methods known from the prior art. It has been another object of the present invention to provide a process for the preparation of dihydrocarbyl metal halides, which allows for high yields of such compounds. It has been a further object of the present invention to provide a process for the preparation of dihydrocarbyl metal halides which allows for high yields of these compounds and a low amount of byproducts. It has been a further object of the present invention to provide a process for the preparation of dihydrocarbyl metal halides, which proceeds faster than processes known from the prior art. It has been a further object of the present invention to provide a process for the preparation of dihydrocarbyl metal halides, which is fast and easy to control and only requires standard safety measures since the pressure during the process is not uncommonly high.

These objects and other objects which will become apparent to the skilled person from the following description of the invention are solved by a process for the preparation of hydrocarbyl metal halides, especially dihydrocarbyl metal halides as described in the following text.

In a first aspect the present invention relates to a process for preparing a hydrocarbyl substituted metal halide, comprising reacting the metal and a hydrocarbyl halide in the presence of a catalytic amount of a dihydrocarbyl sulfoxide or a dihydrocarbyl formamide or a mixture of both and in the presence of a dihydrocarbyl metal halide, in a reaction vessel under pressure, wherein the pressure in the reaction vessel is increased after a decrease at least once during the reaction after the reaction has started.

In a second aspect, the present invention relates to a process for preparing a hydrocarbyl substituted metal halide, comprising reacting the metal and a hydrocarbyl halide in the presence of a catalytic amount of a dihydrocarbyl formamide.

With regard to the second aspect of the present invention it has been found that the use of a dihydrocarbyl formamide as a catalyst results in excellent yields with short reaction times. The features described in the following text thus relate to all aspects of the present invention, as long as not explicitly stated otherwise.

### DETAILED DESCRIPTION OF THE PREFERRED EMBODIMENTS

The present process allows for the preparation of hydrocarbyl metal halides, especially dihydrocarbyl metal halides, from the metal in its free metallic state and in substantially a single step process. The process is safe, economical, advantageous and provides excellent yields. The product can be used directly for the preparation of heat stabilizers for plastics. The process is much less expensive in that both the amount and cost of the catalyst are relatively low in comparison to prior catalysts, and the metal can be used in a less expensive form, for example, granules as compared to powder. Additionally, process conditions allow for a safe operation which is surprisingly quick and thus economically favorable.

The present process comprises preparing a hydrocarbyl substituted metal halide from the metal in its metallic state and a hydrocarbyl halide by reacting the metal and hydrocarbyl halide at a reaction temperature, preferably in a liquid organic medium, and in the presence of a catalytic amount of a complex formed between the hydrocarbyl substituted metal halide and a dihydrocarbyl substituted sulfoxide or a dihydrocarbyl substituted formamide or a mixture of both.

Considering the reactants initially employed, the metal is preferably tin but may also be lead, antimony, zinc, cadmium, and mixtures of two or more of these five metals. The form of the metal is not critical but preferably the metal is present in a comminuted form. A finely divided particulate form tends to speed the reaction, but one of the advantages of the present process is that the metal may be used in relatively large particle or granular size such as tin or lead shot, mossy zinc, tin foil, metal turnings, and the like.

The hydrocarbyl halide may be represented by the formula RX, in which R is the hydrocarbyl group and X is halogen such as fluorine, iodine, bromine, and preferably chlorine. As used here and in the claims the term “hydrocarbyl” relates to substituted or unsubstituted, saturated or unsaturated linear or branched alkyl, isoalkyl, cycloalkyl, each R independently from each other having from 1 up to 18 carbon atoms, such as methyl, ethyl, propyl, butyl, pentyl, hexyl, heptyl, octyl, amyl, isopropyl, isobutyl, isopentyl, cyclopropyl, cyclohexyl, methylcyclohexyl, alkenyl, isoalkenyl, and cycloalkenyl like cyclopropenyl, cyclobutenyl, cyclopentenyl, cyclohexenyl, etc.; alkoxy up to 10 carbon atoms, such as methoxy, ethoxy, propoxy, and aryl, alkaryl, aralkyl, halo-substituted aryl, and alkoxy-substituted aryl, such as phenyl, tolyl, xylyl, ethylphenyl, benzyl, phenylethyl, chlorophenyl, dibromophenyl, bromotolyl, methoxyphenyl, ethoxyphenyl and the like. It is important with regard to the process of the present invention that the hydrocarbyl halide employed is in a substantially gaseous state at a temperature of the reaction under ambient pressure. The hydrocarbyl halide, however, can be partially or completely condensed at the temperature of the reaction due to the pressure in the reactor.

In a preferred embodiment of the present invention the radical R in RX stands for a linear or branched, saturated alkyl radical with 1 to 12, especially with 1 to 6 a carbon atoms. It is most preferred, when the radical R stands for methyl, ethyl, propyl or butyl, especially for methyl or ethyl.

In another preferred embodiment of the present invention, X stands for chlorine or bromine, in most preferred embodiment for chlorine.

The dihydrocarbyl substituted sulfoxide used according to the present invention may be represented by the formula R₂SO in which the radicals R independently from each other stand for a hydrocarbyl group as defined above.

The dihydrocarbyl substituted formamide used according to the present invention may be represented by the formula R₂N(H)CO in which the radicals R independently from each other stand for a hydrocarbyl group as defined above. It is preferred according to the present invention, if the hydrocarbyl groups in said dihydrocarbyl sulfoxide or in said dihydrocarbyl formamide are the same or different and are selected from the group consisting of C₁₋₁₂-alkyl, C₁₋₁₂-isoalkyl, C₃₋₁₂-cycloalkyl, C₁₋₁₂-alkenyl, C₁₋₁₂-isoalkenyl or C₄₋₁₂-cycloalkenyl.

As for both materials it is preferred if the radicals R in each compound (sulfoxide or formamide) are identical and have up to 6 carbon atoms, especially 1, 2, 3 or 4 carbon atoms. In a most preferred embodiment of the present invention, dimethyl sulfoxide or dimethyl formamide or their mixture are used as a catalyst.

Without wishing to be bound by a theory, it is believed, that the actual catalytic reaction is due to a complex formed between the dihydrocarbyl sulfoxide or the dihydrocarbyl formamide and a hydrocarbyl substituted metal halide. Thus, according to the present invention, the reaction mixture initially also contains a dihydrocarbyl metal halide or mixture of two or more dihydrocarbyl metal halides. Within the scope of a preferred embodiment of the present invention the dihydrocarbyl metal halide is a dihydrocarbyl tin halide.

The complex which is believed to catalyze the reaction and which can be formed by the hydrocarbyl substituted metal halide or a metal halide and the dihydrocarbyl substituted sulfoxide or formamide in the reaction mixture may have the formula

RₙMX₍₄₋ₙ)*m R₂SO or RₙMX₍₄₋ₙ₎*m R₂N(H)CO

in which M represents tin, lead, antimony, zinc and cadmium, R represents a monovalent hydrocarbyl substituent as defined above, X represents a halogen, n represents a whole number of from 0 to 3, especially from 1 to 3 inclusive, and m represents a whole number of from 1 to 5 inclusive. Exemplary complexes are: Me₂SnCl₂*2DMSO, MeSnCl₃*2DMSO, Me₃SnCl*DMSO and SnCl₄*2DMSO. Similar or identical complexes are formed with DMF.

Preferably, the complex has the formula

RₙSnCl₍₄₋ₙ₎*2 R₂SO or RₙSnCl₍₄₋ₙ₎*2 R₂N(H)CO,

in which R represents a hydrocarbyl radical as defined above, especially alkyl, isoalkyl, cycloalkyl, each up to 12 carbon atoms.

When R is methyl and n is 2, the complex is a white solid having a melting point of 111° C. to 113° C. The ratio in the complex of two moles of dimethyl sulfoxide to one mole of dimethyl tin dichloride was confirmed by analysis and infrared spectra according to U.S. Pat. No. 3,954,820.

According to the process of the present invention, the metallic metal is reacted with a hydrocarbyl halide in the presence of a catalytic amount of a complex formed between the hydrocarbyl substituted metal halide and a dihydrocarbyl substituted sulfoxide. The complex then catalyzes further reaction between the metal and hydrocarbyl halide.

The hydrocarbyl substituents in the halide and in the sulfoxide may be the same or different, and in all cases are selected from the group consisting of alkyl, isoalkyl, or cycloalkyl, each up to 12 carbon atoms; alkenyl, isoalkenyl, and cycloalkenyl, each up to 12 carbon atoms; alkoxy up to 10 carbon atoms; aryl, alkaryl, aralkyl, halo-substituted aryl, and alkoxy-substituted aryl, each up to 12 carbon atoms, as defined above. The preferred metal is tin, although lead, antimony, zinc, cadmium, and admixtures of all of these metals may also be used.

The process according to the present invention can generally be performed with the constituents mentioned above, as long as sufficient heat transfer, mixing and contact surface of the reagents can be ensured in the reaction vessel. Advantageously, the medium present in the reaction vessel should be liquid enough to allow for stirring and intimate contact between the reagents. Providing a liquid reaction medium can be done basically in any way known to the skilled person. It has, e.g., been proven to be successful if the liquid reaction medium is obtained by having one of the reagents present in the molten state in the reaction vessel or having a pressure in the reaction vessel at which a gaseous component is present in the condensed state. It is thus not generally necessary to introduce a separate liquid into the reaction vessel, if one or more of the above conditions are met.

It can be advantageous for the process according to the present invention if the reaction is performed in a liquid organic medium. The liquid organic medium merely provides an arena for the reaction to take place by serving as a solvent for the hydrocarbyl halide and the complex. Essentially, the liquid is a heat-transfer medium and, in this form of the invention, should be sufficiently chemically inactive with respect to the reactants and heat-resistant at the temperature of the reaction. A large number of organic liquids and solvents meets these requirements, such as mineral oil, benzene, toluene, heptane, octane, iso-octane, the cellosolves, isooctyl thioglycloate, kerosene, fuel oil, the glycols such as ethylene glycol, tetrahydrofuran, dibutyl ether and the like.

The liquid organic medium, used as a heat-transfer agent in the process, may comprise any organic liquid such as benzene, toluene, and the like. However, preferably the liquid organic medium is the hydrocarbyl halide, or the hydrocarbyl substituted metal halide or the dihydrocarbyl substituted metal halide, or a mixture thereof if either is liquid at reaction temperatures and pressures. A preferred product is dialkyl tin dichloride and especially dimethyl tin dichloride.

According to the process of the present invention, the pressure in the reaction vessel is increased after a decrease at least once during the reaction after the reaction has started. It has proven to be a key factor with regard to the present invention that the pressure in the reaction vessel is varied in this way at least once during the reaction.

Before the reaction starts but after the reaction vessel has already been heated or is in the process of being heated, the reaction vessel has a pressure above the surrounding pressure. Preferably the pressure is above 100 kPa, especially between 103,42 kPa (15 psi) and 1379 kPa (200 psi). The initial pressure of the reaction vessel, that is the pressure of the reaction vessel before the heating is started, can generally be ambient pressure or above. It has proven to be successful if the pressure in the reaction vessel prior to heating is raised above ambient pressure, e.g., above about 103 kPa. The initial pressure of the reaction vessel should, however, be chosen such that the pressure in the reaction vessel at reaction temperature is not above about 1379 kPa (200 psi). During the reaction, the pressure in the reaction vessel is between about 103,42 kPa (15 psi) and about 1379 kPa (200 psi). The initial pressure prior to heating can, e.g., be raised by the introduction of gaseous hydrocarbyl halide. It is, however, also possible to introduce other gases which do not take part in the reaction.

When the reaction starts, generally a pressure drop is noticed due to the consumption of hydrocarbyl halide. According to the present invention, the pressure is increased again by the introduction of additional hydrocarbyl halide

In a preferred embodiment of the present invention, the concentration of hydrocarbyl halide is increased after a decrease at least once during the reaction after the reaction has started. It has surprisingly proven to be a very efficient way of accelerating the reaction according to the invention when the pressure in the reaction vessel is left to decrease from a certain initial value and is then, after the consumption of hydrocarbyl halide up to a certain extent has happened, increased again by introduction of additional hydrocarbyl halide. This variation in reactor pressure, preferably due to intermittent introduction of hydrocarbyl halide into the reaction vessel, results in a process which is safe to operate, since the maximum pressure in the reactor is in a safe range, and, additionally, results in a surprisingly clean product in a surprisingly fast reaction time. It is thus the preferred feature of the present invention that hydrocarbyl halide is intermittently introduced into the reaction vessel during the reaction, which, in turn, results in the pressure changes which are characteristic features of the process according to the present invention.

The extent of the pressure changes can generally be chosen freely. For instance, the pressure in the reaction vessel can be raised after a drop of about 1, 2, 5, 10, 20, 50, 75 or 100 kPa or more, e.g., about 200 or less, 400 or less, 600 or less, 800 or less, 1000 or less or 1200 kPa or less. As a guideline, it has proven to be advantageous to raise the pressure by introduction of hydrocarbyl halide into the reaction vessel after a pressure drop of about 1% to about 80% from the pressure at the start of the reaction, e.g., after a pressure drop of about 2% to about 50%, or about 3% to about 40%, or about 5% to about 30%, or about 10% to about 20% from the pressure at the start of the reaction.

Increasing the pressure in the reaction vessel by introduction of hydrocarbyl halide, however, does not necessarily have to be performed in dependence from the initial pressure in the reactor. Generally, any pressure during the course of the reaction can be chosen as a basis for an increase of the pressure in the reaction vessel. For instance, after an initial drop of the pressure in the reaction vessel of about 20 percent after the start of the reaction, the resulting value can be chosen as a base value for the beginning of the calculation of the pressure drop. This value, however, does not have to be fixed during the course of the reaction. Basically any pressure in the reaction vessel during the course of the reaction can be chosen as a base value for the calculation of the pressure drop, as long as the pressure in the reaction vessel starting from this value would drop without introduction of additional hydrocarbyl halide.

In that the case is it has been proven to be advantageous if the ratio of the pressure chosen as the base value for the beginning of the calculation of the pressure drop to the pressure at which the pressure in the reactor is being raised is about 1,01 to about 5, e.g., about 1,05 to about 2, or about 1,1 to about 1,5. For example, the pressure in the reaction vessel during the reaction is increased at least once by a factor of at least about 1,05.

The number of pressure increases by additional introduction of hydrocarbyl halide during the course of the reaction can generally be chosen freely. The upper limit is, however, the extent to which the metal in the reactor has been consumed. If the reaction has stopped due to metal consumption, additional pressure increase in the reactor by addition of hydrocarbyl halide will not result in further pressure drop. The number of pressure increases during the course of the reaction is favourably chosen in a range of about 1 to about 150, e.g., about 2 to about 130, or about 5 to about 100, or about 10 to about 90.

It should be noted, that the above pressures and changes in pressures should be calculated based on a basically constant temperature. The above described pressures and pressure changes should be calculated normalized to a constant reaction temperature.

During the reaction the reaction temperature is within a range of from about 80° C. to about 230° C. Preferably, the reaction temperature is in a range of about 150 to about 220, or about 160 to about 210, or about 170 to about 200° C., especially about 180 to about 190° C.

The temperature during the reaction should generally be held constant during the reaction. It may, however, be impossible, to allow for changes in the reaction temperature, e.g., due to exothermal reaction profiles, of about 10 percent around the chosen reaction temperature. At a chosen reaction temperature of 200° C., this would correspond to the fluctuation in reaction temperature of from about 180 to about 220° C. It is, however, preferred if the fluctuation of the reaction temperature is less than 10 percent around chosen reaction temperature, e.g., about 8% or less or about 6% or less or about 5% or less or about 3% or less.

It is another aspect of the present invention that surprisingly the catalyst employed has been found to be recyclable under the conditions of the present invention. Thus, in the process according to the present invention the product formed during the reaction can be removed from the reaction vessel, e.g., by distillation. The remainder still contains the catalytically active compounds. Thus, in a process according to the present invention, the employed catalyst can be a recycled catalyst.

The hydrocarbyl halide should be present in about stoichiometric quantities or in a small excess with respect to the metal over the indicated 2:1 molar ratio, for example about 1% by weight excess, not only to make that reaction proceed, but also because some of the resulting dihydrocarbyl metal halide, reacts with the dihydrocarbyl sulfoxide to form the complex. The amount of the dihydrocarbyl sulfoxide or dihydrocarbyl formamide used can be regulated to provide a catalytic amount of the complex, for example, an amount of about 0,5% to about 30% or about 1% to about 20% or about 2% to about 15% or about 3% to about 10% or about 3,5% to about 7%, based on the weight of the dihydrocarbyl sulfoxide or dihydrocarbyl formamide or their mixture, to the weight of the metal.

In this manner, the over-all net effect is that the complex catalyzes a reaction between the metal and the hydrocarbyl halide to form the hydrocarbyl substituted metal halide. The preferred product is dimethyl tin dichloride.

In an improved form of the invention, the function of the liquid organic medium is supplied by one of the reactants itself, if such reactant is liquid under the conditions of the reaction. For example, if either the hydrocarbyl halide or the hydrocarbyl substituted metal halide or the dihydrocarbyl substituted metal halide is liquid under the temperature and pressure conditions of the reaction, it can supplant the use of a non-reactive, inert organic liquid previously described. As examples, propyl chloride, butyl chloride, dimethyl tin dichloride, and dibutyl tin dichloride are liquid at either room temperatures or at the usual elevated temperatures, and pressures at which the catalyzed process usually takes place. They can therefore be used, especially under pressure, as the heat-transfer medium as well as a reactant of the reaction. On the other hand, methyl chloride is normally a gas and cannot be used in this manner.

In another aspect of the present invention, the use of the residue of the reaction after removal of the product, as the catalyst, is disclosed. The present invention thus also relates to the use of a residue, obtainable by a process for preparing a hydrocarbyl substituted metal halide, comprising reacting the metal and a hydrocarbyl halide in the presence of a catalytic amount of a dihydrocarbyl sulfoxide or a dihydrocarbyl formamide or a mixture of both and in the presence of a dihydrocarbyl metal halide, in a reaction vessel, wherein the reaction product is removed by distillation, as a catalyst.

The following examples are intended only to illustrate the invention and should not be construed to impose limitations on the claims. Compositions are by weight present unless otherwise indicated.

### EXAMPLES

### Example 1

### Catalyst Preparation

Tributylamine (63,6 g; 0,34 moles) was taken in a 500 ml round bottom flask fitted with an overhead stirrer, thermometer pocket and condenser. Stannic chloride (89,7 g; 0,34 moles) was added slowly under stirring over a period of 1 hr. The temperature of the reaction rose from 29° C. to 65° C. After the addition was complete, the reaction mass was heated to 100° C. under stirring and cooled to room temperature.

### Example 2

### Preparation of Dimethyl Tin Dichloride

The catalyst prepared above (145 g) was charged into a 1-liter stainless steel autoclave, followed by tin granules (200 g; 1,68 gm-atom). Air was expelled from the reactor by filling it with nitrogen and releasing the nitrogen into the atmosphere. A methyl chloride cylinder was connected to the reactor. The cylinder was kept warm by placing it in a hot water bath. The mixture of catalyst and tin was heated to 185° C. under stirring and methyl chloride introduced till the pressure had reached 120 psi. The reaction started immediately as seen by a drop in pressure in the reactor. When the pressure had dropped to 100 psi, methyl chloride was again introduced till the pressure had reached 120 psi. This was continued till no pressure drop was observed, indicating completion of the reaction (330 min.). After the reaction had cooled to about 85° C. the excess methyl chloride was slowly vented. Nitrogen was introduced and this too was vented. This ensured that no residual methyl chloride was present when the reactor was opened to remove the product. The amount of methyl chloride consumed was 165 g (3,3 moles) indicating that all the tin had reacted. The crude product was purified by vacuum distillation to give a white product that was analysed by gas chromatography, and the product distribution was monomethyltin trichloride 3,4%, dimethyl tin chloride 88% and trimethyl tin chloride 0,2%.

### Examples -10

The procedure of Example 2 was repeated with various catalysts, prepared as given in Example 1. When complexes between phosphine and stannic chloride were used, the amine was replaced by phosphine; all other reaction conditions were similar. The results are shown in Table 1.

### Examples 11-12

The catalyst in these Examples was a complex between DMSO and dimethyltin dichloride in the molar ratio 2:1 respectively. Additional quantity of DMTDC was used as solvent. All other conditions were as for Example 2. The results are shown in Table 2.

### Examples 13-15

These reactions were conducted as described for Example 11 and 12, except that along with tin, catalyst and DMTDC, methyl chloride was introduced till the pressure in the reactor was about 30 psi. All other conditions were the same. The results are shown in Table 3.

### Example 16-17

### Recycle Studies

These reactions were conducted as given in Example 2, except the residue of Example 16 after distillation of the product was recycled in Example 17. The residue is expected to be the catalyst; however, the reaction did not go to completion, demonstrating that catalyst recycle is not feasible. The results are shown in Table 4.

### Example 18-19

These reactions demonstrate the recyclability of the catalyst 2 DMSO:DMTDC. The first reaction (Example 15, Table 3) was conducted as described for Example 13 and 14. After distillation of the product, the residue was used as catalyst for the next reaction. The results are shown in Table 5. As can be seen from the data in Table 5, the catalyst was easily recyclable.

### Example 20-21

These reactions were conducted as given in Example 2, except that DMF (Example 20) and 2DMF*SnCl₄ (Example 21) were used as catalyst, and, in addition, methyl chloride was introduced till the pressure in the reactor was about 30 psi. The results are shown in Table 6.

TABLE 1

| Example | | | | | | | | | | | |
|---|---|---|---|---|---|---|---|---|---|---|---|
| No. (No. of | | | Amine/ | Stannic | | | MeCl | | Methyltin | Dimethyltin | Trimethyltin |
| pressure | Tin | | phosphine | chloride | Temp. | Time | consumed | Unreacted | trichloride | dichloride | chloride |
| increases) | (g) | Amine/phosphine | (g) | (g) | ° C. | (min) | (g) | tin (g) | GC % | GC % | GC % |
| 3 (56) | 200 | triethylamine | 33.5 | 86.5 | 185 | 165 | 160 | — | 4.3 | 92.3 | 0.3 |
| 4 (65) | 225 | tripropylamine | 54.9 | 100.1 | 185 | 180 | 195 | — | 3.2 | 96.8 | — |
| 5 (58) | 60 | trioctylamine | 36 | 26.6 | 185 | 270 | 50 | — | 11.3 | 85.6 | 0.4 |
| 6 (59) | 200 | dimethylamino- | 71.8 | 87.9 | 185 | 250 | 170 | — | 9 | 89 | 0.3 |
| | | dodecane | | | | | | | | | |
| 7 (60) | 60 | 1-methyldidecyl- | 31.4 | 26.4 | 185 | 195 | 45 | 2 | 10.8 | 86.8 | 0.2 |
| | | amine | | | | | | | | | |
| 8 (65) | 200 | tributylphosphine | 67.5 | 87.1 | 185 | 150 | 165 | — | 5.6 | 92.6 | 0.2 |
| 9 (41) | 122 | trioctylphosphine | 75.9 | 53.4 | 185 | 580 | 100 | — | 3 | 97.6 | 0.1 |
| 10 (52) | 200 | triphenylphosphine | 89.2 | 86.8 | 185 | 240 | 150 | 40 | 11.6 | 87.5 | 0.2 |

TABLE 2

| Example No. (No. | | | | | | MeCl | | Methyltin | Dimethyltin | Trimethyltin |
|---|---|---|---|---|---|---|---|---|---|---|
| of pressure | Tin | DMSO | DMTDC | Temp. | Time | consumed | Unreacted | trichloride | dichloride | chloride |
| increases) | (g) | (g) | (g) | ° C. | (min) | (g) | tin (g) | GC % | GC % | GC % |
| 11 (76) | 300 | 15 | 150 | 200 | 360 | 250 | 6.5 | 0.5 | 95.8 | 1.5 |
| 12 (74) | 300 | 15 | 150 | 200 | 300 | 245 | 10 | 1.1 | 91.1 | 2 |

TABLE 3

| Example | | | | | | | | | | | |
|---|---|---|---|---|---|---|---|---|---|---|---|
| No. (No. of | | | | MeCl added | | | MeCl | | Methyltin | Dimethyltin | Trimethyltin |
| pressure | Tin | DMSO | DMTDC | initially | Temp. | Time | consumed | Unreacted | trichloride | dichloride | chloride |
| increases)). | (g) | (g) | (g) | (g) | ° C. | (min) | (g) | tin (g) | GC % | GC % | GC % |
| 13 (64) | 300 | 15 | 150 | 15 | 200 | 180 | 255 | — | 0.8 | 98.9 | 0.3 |
| 14 (68) | 300 | 15 | 150 | 15 | 200 | 180 | 255 | — | 1 | 96.6 | 0.2 |
| 15 (48) | 200 | 10 | 200 | 15 | 200 | 180 | 170 | — | 1.5 | 98.1 | 0.6 |

TABLE 4

| Example | | | | | | | | | | | |
|---|---|---|---|---|---|---|---|---|---|---|---|
| No. (No. of | | | | Stannic | | | MeCl | | Methyltin | Dimethyltin | Trimethyltin |
| pressure | Tin | | Amine | chloride | Temp. | Time | consumed | Unreacted | trichloride | dichloride | chloride |
| increases) | (g) | Amine | (g) | (g) | ° C. | (min) | (g) | tin (g) | GC % | GC % | GC % |
| 16 (76) | 400 | dimethylamino- | 106.5 | 130.4 | 185 | 395 | 330 | <5 | 3.6 | 92.6 | 0.2 |
| | | dodecane | | | | | | | | | |
| 17 (15) | 350 | Distillation residue | — | — | 185 | 450 | 280 | 35 | 3.2 | 92.9 | 0.2 |
| | | from Example 16 | | | | | | | | | |
| | | 210 g | | | | | | | | | |

TABLE 5

| Example | | | | MeCl | | | | | | | |
|---|---|---|---|---|---|---|---|---|---|---|---|
| No. (No. of | | | Quantity of | added | | | MeCl | | Methyltin | Dimethyltin | Trimethyltin |
| pressure | Tin | Distillation residue | distillation | initially | Temp. | Time | consumed | Unreacted | trichloride | dichloride | chloride |
| increases) | (g) | from Example No. | residue (g) | (g) | ° C. | (min) | (g) | tin (g) | GC % | GC % | GC % |
| 18 (60) | 200 | 17 | 245 | 15 | 200 | 180 | 170 | — | 0.8 | 98.6 | 0.3 |
| 19 (41) | 200 | 18 | 195 | 15 | 200 | 180 | 170 | — | 1 | 98.7 | 0.3 |

TABLE 6

| Example | | | | | | | | | | | | |
|---|---|---|---|---|---|---|---|---|---|---|---|---|
| No. (No. of | | | | | MeCl added | | | MeCl | | Methyltin | Dimethyltin | Trimethyltin |
| pressure | Tin | DMF | SnCl₄ | DMTDC | initially | Temp. | Time | consumed | Unreacted | trichloride | dichloride | chloride |
| increases)) | (g) | (g) | (g) | (g) | (g) | ° C. | (min) | (g) | tin (g) | GC % | GC % | GC % |
| 20 (46) | 60 | 6 | 10.7 | 30 | — | 200 | 180 | 50 | — | 6.8 | 85.3 | 0.2 |
| 21 (70) | 90 | 9 | — | 45 | 15 | 200 | 300 | 60 | 16.6 | 0.6 | 97.2 | 1.2 |

1. A process for preparing a hydrocarbyl substituted metal halide, comprising reacting the metal and a hydrocarbyl halide in the presence of a catalytic amount of a dihydrocarbyl sulfoxide, a dihydrocarbyl formamide or a mixture thereof and in the presence of a dihydrocarbyl metal halide, in a reaction vessel under pressure, wherein the pressure in the reaction vessel is increased after a decrease at least once during the reaction after the reaction has started.

2. The process according to claim 1, wherein the concentration of hydrocarbyl halide is increased after a decrease at least once during the reaction after the reaction has started.

3. The process according to claim 1, wherein hydrocarbyl halide is intermittently introduced into the reaction vessel during the reaction.

4. The process according to claim 1, wherein the hydrocarbyl groups in said dihydrocarbyl sulfoxide or in said dihydrocarbyl formamide are the same or different and are selected from the group consisting of C1-12-alkyl, C1-12-isoalkyl, C3-12-cycloalkyl, C1-12-alkenyl, C1-12-isoalkenyl and C4-12-cycloalkenyl.

5. The process according to claim 1, wherein the metal is selected from the group consisting of tin, lead, antimony, zinc, cadmium, and mixtures of two or more of these metals.

6. The process according to claim 1, wherein the dihydrocarbyl metal halide is a dihydrocarbyl tin halide.

7. The process according to claim 1, wherein the reaction temperature is from 80° C. to 230° C.

8. The process according to claim 1, wherein the reaction is performed in a liquid organic medium.

9. The process according to claim 8, wherein the liquid organic medium is selected from the group consisting of said hydrocarbyl halide if liquid at reaction temperatures; said hydrocarbyl substituted metal halide, or a mixture thereof.

10. The process according to claim 1, wherein the pressure in the reaction vessel during the reaction is between 15 psi and 200 psi.

11. The process according to claim 1, wherein the pressure in the reaction vessel during the reaction is increased at least once by a factor of at least 1.05.

12. The process according to claim 1, wherein the catalyst is a recycled catalyst.

13. A process for preparing a hydrocarbyl substituted metal halide, comprising reacting a metal and a hydrocarbyl halide in the presence of a catalytic amount of a dihydrocarbyl formamide in a reaction vessel under pressure, wherein the pressure in the reaction vessel is increased after a decrease at least once during the reaction after the reaction has started.

14. A process for preparing a hydrocarbyl substituted metal halide, comprising reacting the metal and a hydrocarbyl halide in the presence of a catalytic amount of a dihydrocarbyl sulfoxide, a dihydrocarbyl formamide or a mixture thereof and in the presence of a dihydrocarbyl metal halide in a reaction vessel, and removing the reaction product by distillation as a catalyst.

15. The process according to claim 13, wherein the concentration of hydrocarbyl halide is increased after a decrease at least once during the reaction after the reaction has started.

16. The process according to claim 13, wherein hydrocarbyl halide is intermittently introduced into the reaction vessel during the reaction.

17. The process according to claim 13, wherein the hydrocarbyl groups in said dihydrocarbyl formamide are the same or different and are selected from the group consisting of C1-12-alkyl, C1-12-isoalkyl, C3-12-cycloalkyl, C1-12-alkenyl, C1-12-isoalkenyl and C4-12-cycloalkenyl.

18. The process according to claim 13, wherein the metal is selected from the group consisting of tin, lead, antimony, zinc, cadmium, and mixtures of two or more of these metals.

19. The process according to claim 13, wherein the pressure in the reaction vessel during the reaction is increased at least once by a factor of at least 1.05.

20. The process according to claim 13, wherein the catalyst is a recycled catalyst.
